(19) United States
(12) Patent Application Publication
(10) Pub. No.: US 2009/0134103 A1
(43) Pub. Date: May 28, 2009

(54) IMPACT RESISTANT, EASY ATTACHMENT SHELF-EDGE RAILS FOR SHELF EDGE MOUNTED ELECTRONIC DISPLAYS

(75) Inventors: Sunit Saxena, Monte Sereno, CA (US); Shan Kumar, San Ramon, CA (US)

Correspondence Address: DLA PIPER LLP (US ), 2000 UNIVERSITY AVENUE, EAST PALO ALTO, CA, 94303-2248, US

(73) Assignee: Altierre Corporation, San Jose, CA (US)

(21) Appl. No.: 11/945,231

(22) Filed: Nov. 26, 2007

(51) Int. Cl. G09F 3/20; A47F 5/00

(52) U.S. Cl. 211/153; 40/651; 40/657

(57) ABSTRACT

A shelf-edge rail device and method are provided that can be easily attached to existing shelves over the built-in C-channels or can be built into the shelves at manufacturing time. In addition to providing the capability for mounting a variety of display devices within the shelf-edge rail device, the shelf-edge rail device is impact resistant and adjustable to configure the angle of display by the display devices. Thus, the shelf-edge rail devices can be angled differently for shelves of different heights to maximize view-ability by a shopper.

### FIELD

A device and method for displaying one or more display devices is described.

### BACKGROUND

A store, such as a supermarket, typically has a layout that has a plurality of “aisles” wherein each aisle is a customer pathway with either one or more rows of shelves of products/items arranged on either side of the aisle or one or more rows of shelves of products/items arranged on one side of the aisle. Each row of shelving is further divided into “bays”—each of which is a unit with multiple shelves for display of items for sale. Each bay of shelving has an edge that has a C-channel built into it for traditionally inserting paper price labels for each item in the particular bay into the C-channel. With the advent of electronic displays such as electronic shelf labels, these C-channels are too narrow and/or shallow to hold an electronic shelf labels and do not provide sufficient protection for these electronic shelf labels or other display devices. Thus, it is desirable to provide a device and method that can hold display devices, including electronic display devices, and provide sufficient impact protection to these display devices such as in a store environment and it is to this end that the shelf edge rail devices are directed.

### BRIEF DESCRIPTION OF THE DRAWINGS

FIG. 1 illustrates a typical store layout with aisles;

FIG. 2A illustrates a store with shelf edge devices installed or built into each shelf;

FIG. 2B illustrates another view of the store with shelf edge devices installed or built into each shelf;

FIGS. 3A-3B are a front view and an isometric view, respectively, of an exemplary embodiment of a shelf edge rail device;

FIG. 4 illustrates more details of an attachment mechanism for the exemplary embodiment of a shelf edge rail device;

FIGS. 5A and 5B illustrate an exemplary embodiment of a shelf edge rail device in a first position and a second position, respectively;

FIG. 6 illustrates more details of an exemplary embodiment of the mounting bracket for the exemplary embodiment of a shelf edge rail device shown in FIG. 3-5;

FIGS. 7A and 7B illustrate further details of the exemplary embodiment of the mounting bracket for the exemplary embodiment of a shelf edge rail device shown in FIG. 3-5; and

FIG. 8 illustrates the exemplary embodiment of a shelf edge rail device shown in FIG. 3-5 with various display devices mounted in the shelf edge rail device.

### DETAILED DESCRIPTION OF ONE OR MORE EMBODIMENTS

The shelf edge rail system and method are particularly applicable to holding an electronic display device in a retail environment and it is in this context that the shelf edge rail system and method are described. However, it will be appreciated, however, that the shelf edge rail system and method has greater utility since it can be used in many different environments in which it is desirable to hold display devices and provide some impact protection for these display devices. Now, a typical store layout and then the store layout with the shelf edge rail system will be described to illustrate the shelf rail system in an exemplary environment.

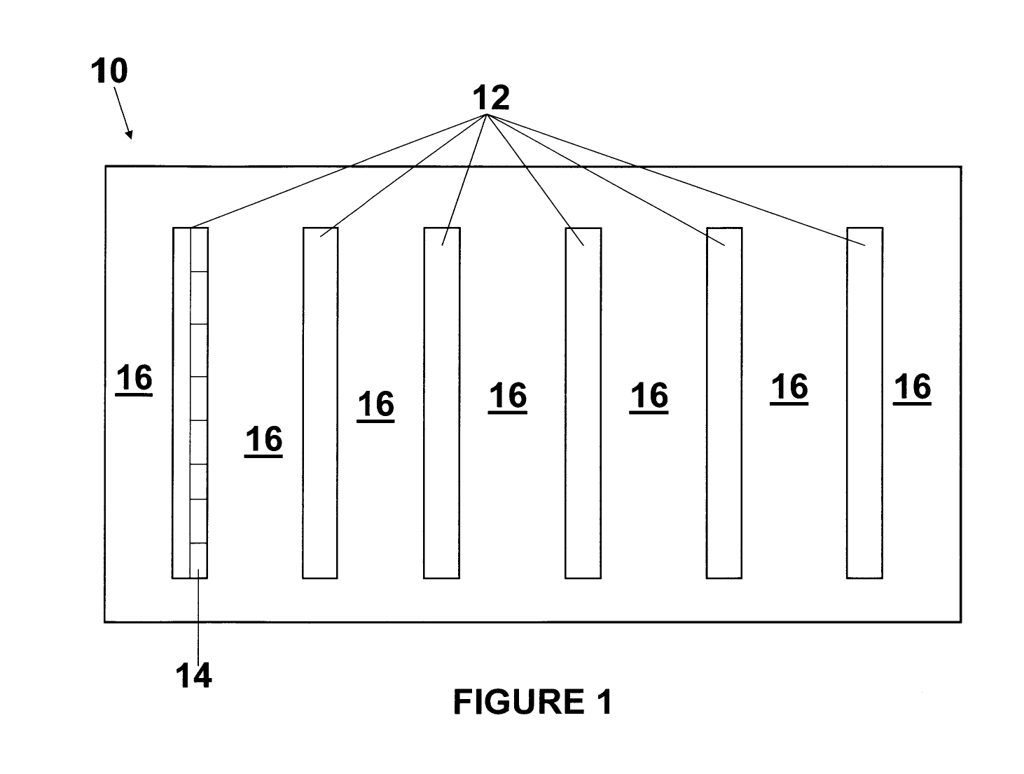

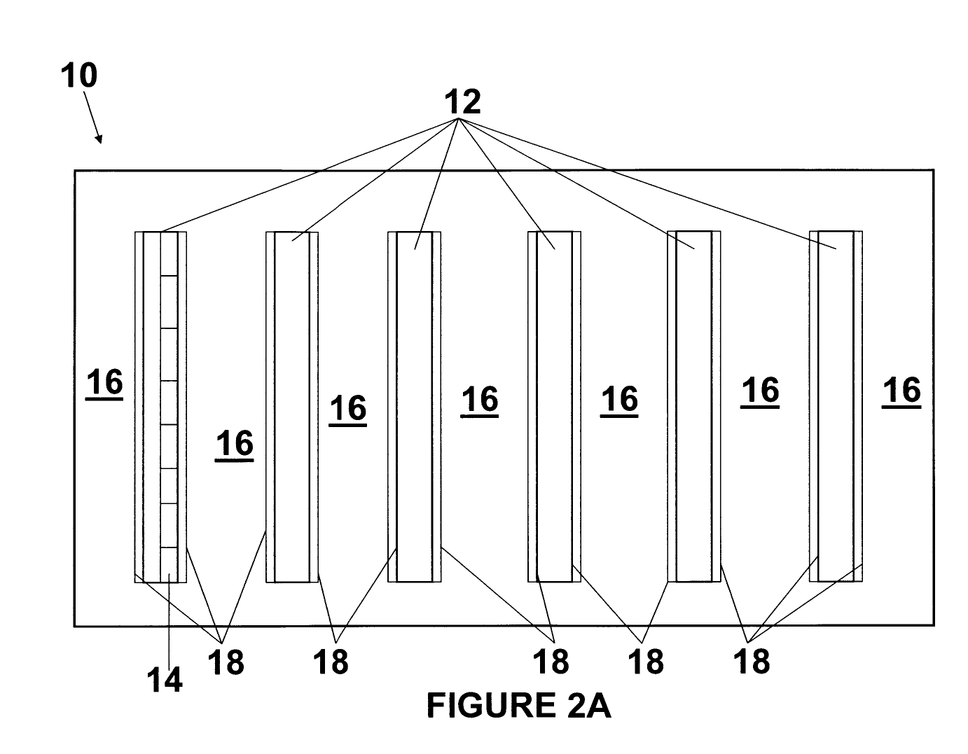

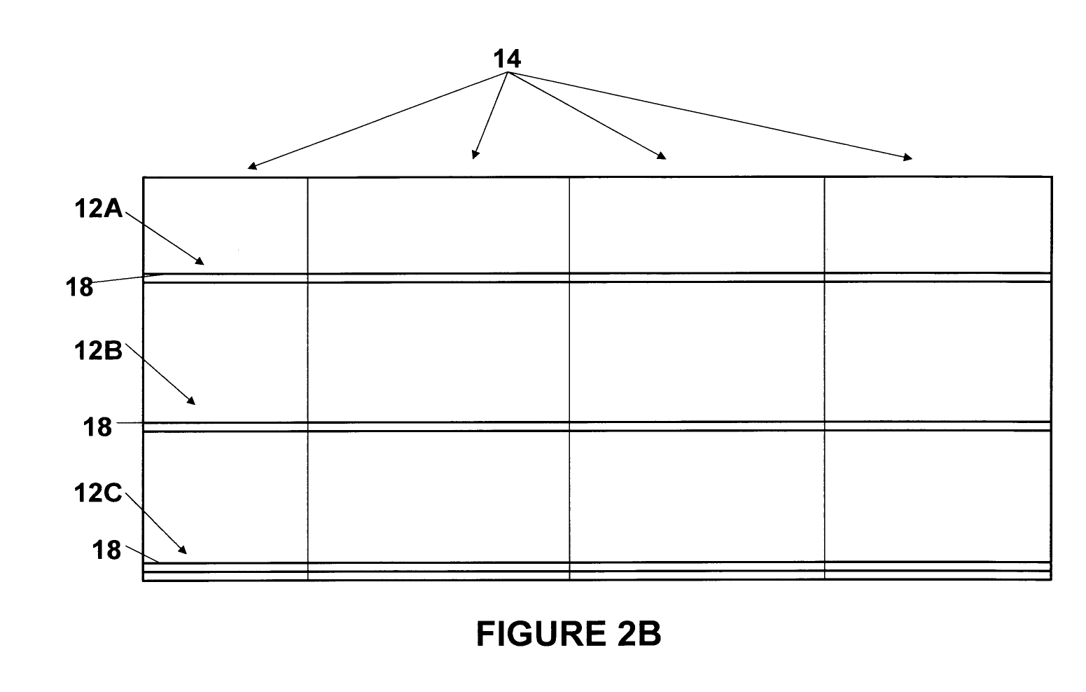

FIG. 1 illustrates a typical store 10 layout. The store, such as a supermarket, may have one or more shelves 12 of items/products that contain items/products so that a customer can see each item/product. Each shelf may further contain one or more bays 14 that divide up the shelf space. Each bay is typically three to four feet in length. The shelves may be at one or more heights above a floor of the store so that items/products on each shelf are at different heights from the floor of the store. The store thus has one or more aisles 16 wherein there may be shelves on both sides or one side of the aisle so that a customer can see the items/products on the shelves. As shown in FIG. 2A, each bay of the each shelf 12 facing the aisle 16 has been retrofitted with a shelf edge device 18 that is part of the shelf rail system. As shown in FIG. 2, the shelf-edge rail devices 18 of the shelf edge rail system may be easily attached to existing bays of the shelves in a store with existing C-channels or the shelf edge rail devices can be pre-built into the shelves during manufacturing time. The shelf-edge rail system provides a way to mount/house a variety of display devices, including electronic display devices. In addition, the shelf-edge rail system is impact resistant and adjustable to configure the angle of display device so that shelf-edge rail system can be angled differently for shelves of different heights to maximize view-ability by the shopper of the display devices contained in the shelf-edge rail system. Now, details of an embodiment of the shelf edge rail system and a particular embodiment of the shelf edge rail device is described in more detail although the shelf edge rail system is not limited to the particular embodiment of the shelf edge rail device illustrated below.

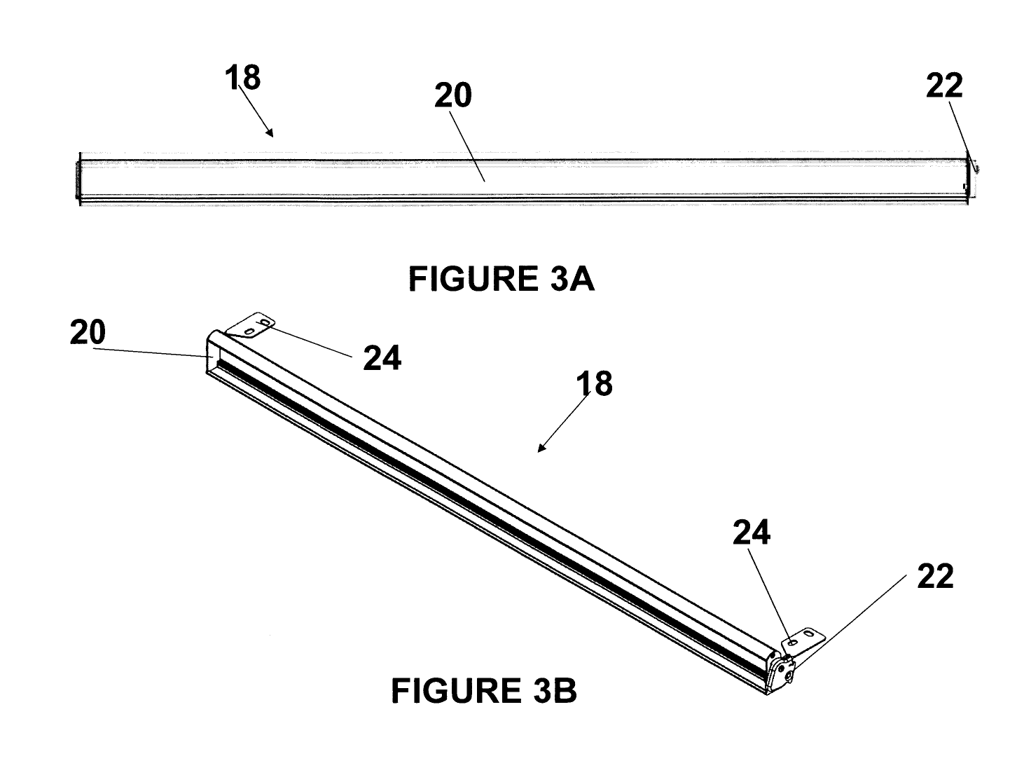

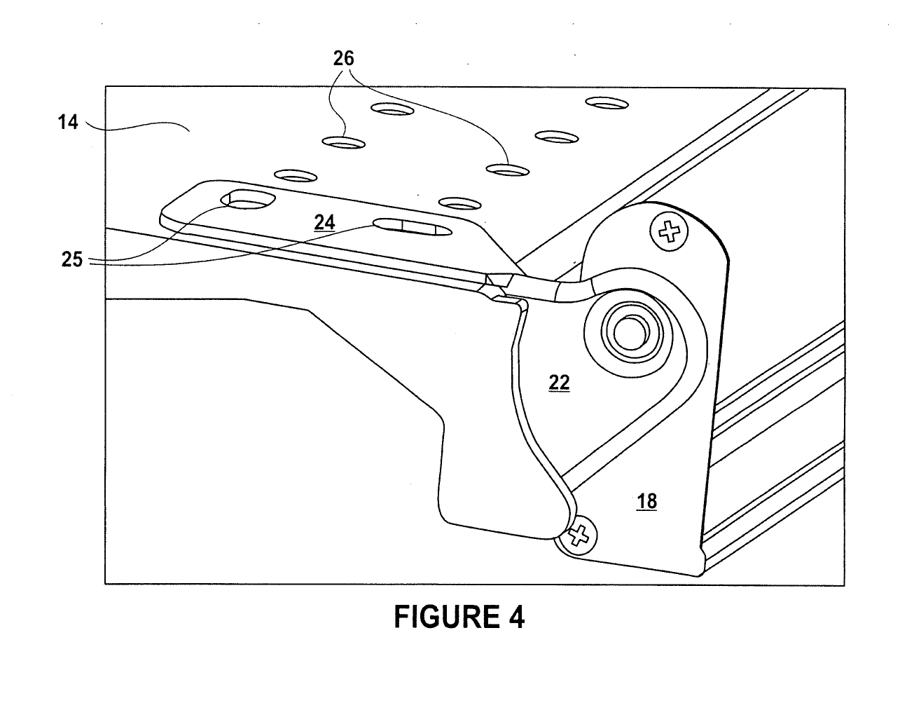

FIGS. 3A-3B are a front view and an isometric view, respectively, of an exemplary embodiment of a shelf edge rail device 18 and FIG. 4 illustrates more details of an exemplary attachment mechanism for the exemplary embodiment of a shelf edge rail device 18. The shelf edge rail device has a mounting channel 20 into and a variety of display devices may be snapped into the mounting channel that may be made of plastic material that has strength (to protect the display devices) and flexibility so that the display devices can be snapped into the mounting channel. In one embodiment, the shelf edge rail device may also include a mounting bracket 22 at one or both ends of the shelf edge rail device that are used to mount the shelf edge rail device on an existing shelf in front of the existing C-shaped channel or to mount the shelf edge rail device during manufacturing on each shelf bay. The shelf edge rail device 18 may be removably attached to each bay or each shelf in a store. In another embodiment, the mounting bracket(s) may be located at the middle of the shelf edge rail device or the mounting bracket(s) also may be located behind the shelf edge rail device. As shown in FIGS. 3B and 4, each mounting bracket 22 may include a tab 24 having mounting holes 25 that may be placed on top of the existing shelf 18 with its mounting holes 26 so that a fastener (not shown) may be placed through the tab mounting holes 25 and the mounting holes 26 of the shelf and thus removably secures the shelf edge rail device to the shelf. The fastener may be, for example, a mechanism that fits through the holes 25, 26 and removably snaps the shelf edge rail device to the shelf. The shelf edge rail device may also be attached by other mechanisms such as adhesive and the like to the top, shelf edge or other parts of the shelf.

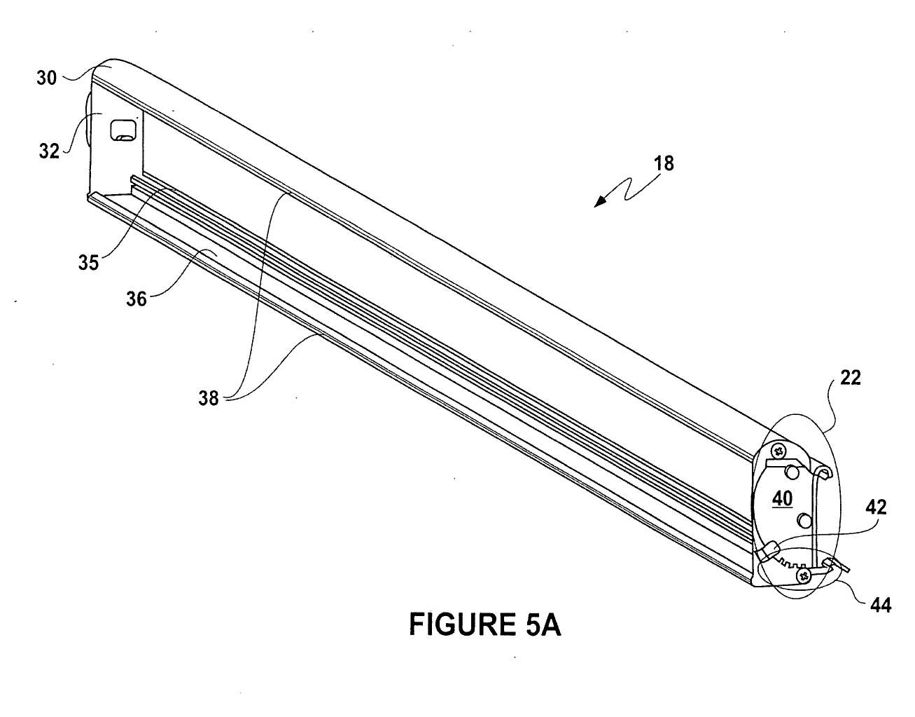

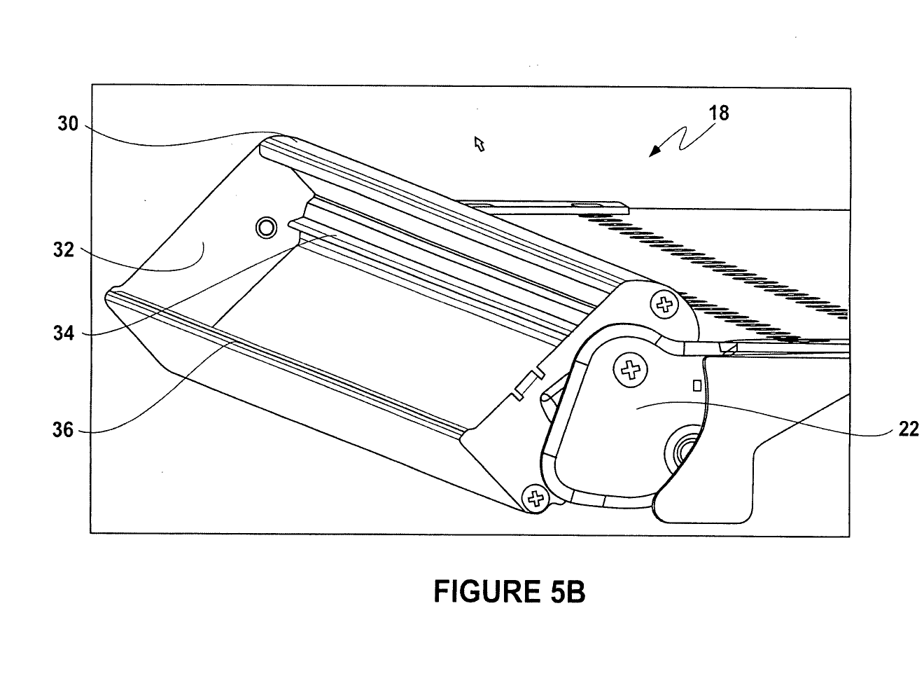

In one embodiment, the mounting bracket may be adjustable (such as the mounting bracket shown in FIGS. 5A-7B) so that the angular position of the shelf edge rail device is adjustable and may then be fixed into an angular position to display the display devices or the paper slips in the channel inside of the shelf edge rail device. In another embodiment, the mounting bracket may have a fixed angle so that the shelf edge rail device has a fixed viewing angle.

FIG. 2B illustrates one or more bays 14 with one or more shelves such as may exist in a store. In the example shown in FIG. 2B, there may be an upper shelf 12A, a middle shelf 12B and a lower shelf 12C although the shelf edge rail device may be used with any bay and shelf configuration. The shelf edge rail device 18 attached to the middle shelf may have an adjustable angular position so that viewing angle of the display devices inserted into the shelf edge rail device may be adjusted. The shelf edge rail device 18 attached to the top and bottom shelf may have a fixed angular position so that the display devices have a fixed viewing angle.

FIGS. 5A and 5B illustrate an exemplary embodiment of a shelf edge rail device 18 in a first position and a second position, respectively. The first position shown in FIG. 5A is a straight position in which a display device mounted in the shelf edge rail device is pointed directly out towards the aisle substantially parallel to the aisle and may be used for example for a shelf at approximately eye level for a consumer and allows those consumers to have an optimal viewing angle for the display device for that shelf The second position shown in FIG. 5B is which angled upwards position in which a display device mounted in the shelf edge rail device is pointed upwards at an angle from the shelf edge rail device so that this position may be used for example for a shelf at closer to the floor of the store to angle the display device mounted on the lower shelf at an optimum angle for viewing by a consumer. The shelf edge rail device may have a plurality of different positions however only two are shown here for illustration purposes and the shelf edge rail device is not limited to a shelf edge rail device that is capable of only these two positions.

As shown in FIGS. 5A and 5B, an exemplary embodiment of the shelf edge rail device 18 may further include a curved top portion 30, and end portion 32 on each end of the shelf edge rail device, one or more biasing strips 34, a C-shaped channel 35 inside of the edge rail device, a curved or straight bottom portion 36 and an optional lip portion 38 on the top and bottom portions. The biasing strip(s) 34, when a display device is mounted in the shelf edge rail device, presses the display device outwards against the top, bottom, front or back portions to ensure that the display device remains in the shelf edge rail device even when the shelf edge rail device is bumped or jostled by a consumer. The end portions 32 may be made of a plastic or metallic material, such as plastic, steel or aluminum for example, and supports the top and bottom portions as well as the mounting bracket that is located on at least one end of the shelf edge rail device. The top and bottom portions may be made of a plastic material that has strength to protect the display devices mounted in the shelf edge rail device and is also flexible to allow the display devices to be snap fitted into the shelf edge rail device. The biasing strip 34 may be made of resilient materials such as a softer plastic material that has a certain amount of spring to securely hold the display devices in the shelf edge rail device. The C-shaped channel 35 inside the edge rail device may be used to hold an ad strip, paper product tag, etc. that is typically inserted into the conventional C-channel so that the shelf edge rail device can be used to accommodate these conventional ad strips, paper product tags, etc.

The mounting bracket 22 may further include a first piece 40 attached to the end portion 32 that also has a ratcheting mechanism 42 and a set of teeth 44 wherein the combination of the ratcheting mechanism 42 and the set of teeth 44 maintain the shelf edge rail device in a particular angular position when the shelf edge rail device is being used for displaying the display devices to the user at the optimal viewing angle. The set of teeth may provide one or more predetermined angular positions for the shelf edge rail device. The angular position of the shelf edge rail device 18 may be changed by overcoming the maintaining force of the ratcheting mechanism 42 which may be done by a person changing the angle of the shelf edge rail device. Thus, the shelf edge rail device maintains its selected angular position during normal use, but the angular position of the shelf edge rail device is manually adjustable.

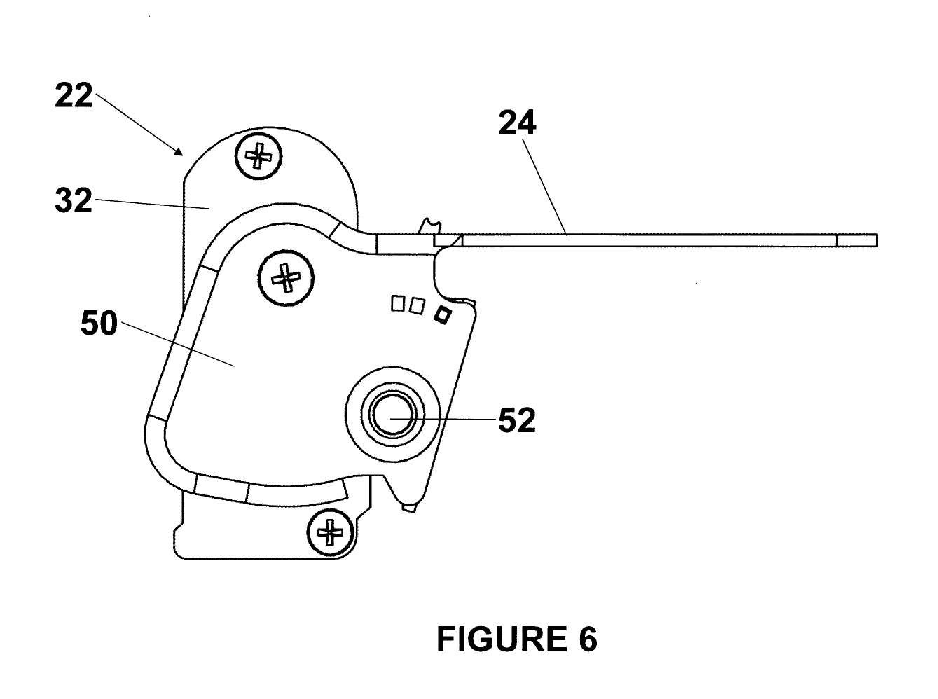

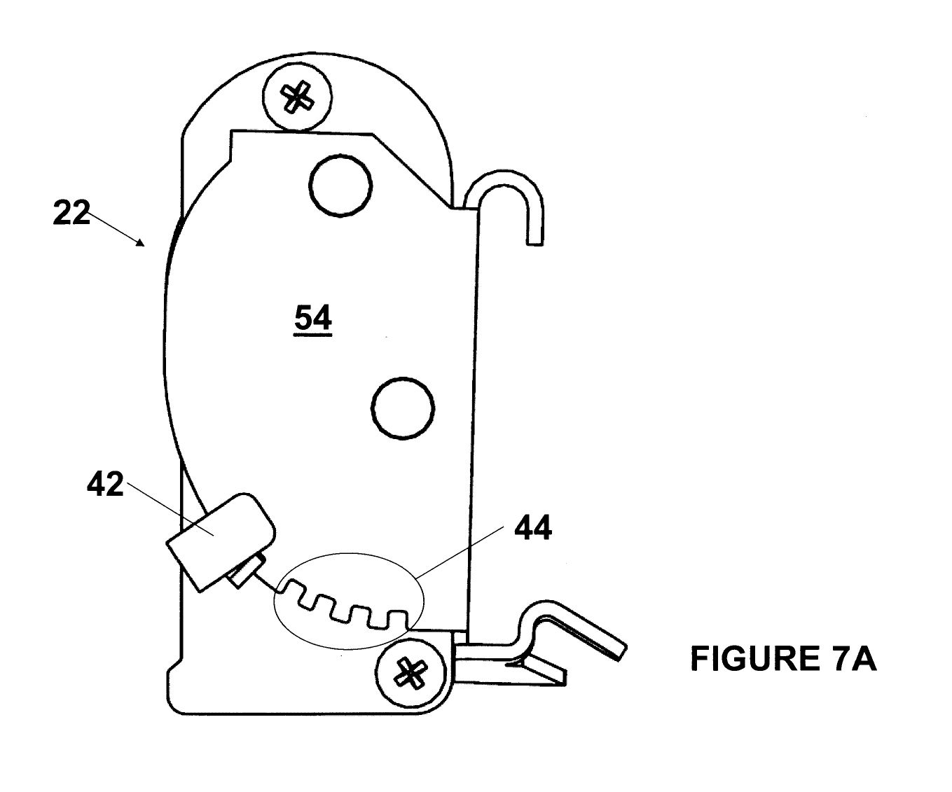

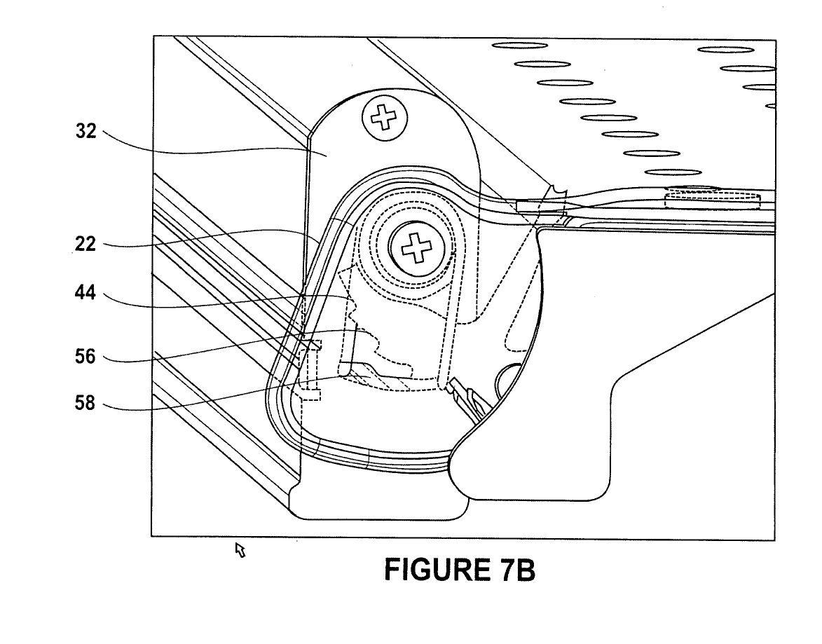

FIG. 6 illustrates more details of an exemplary embodiment of the mounting bracket for the exemplary embodiment of a shelf edge rail device shown in FIG. 3-5 and FIGS. 7A and 7B illustrate further details of the exemplary embodiment of the mounting bracket for the exemplary embodiment of a shelf edge rail device shown in FIG. 3-5. In addition to the tab 24, the mounting bracket 22 may include an outer portion 50 and a rotation point 52 about which the mounting bracket rotates to change the angular position of the shelf edge rail device. The mounting bracket may further include an inner portion 54 (shown in FIG. 7A) that includes the ratcheting mechanism 42 and the set of teeth 44 as described above. In the exemplary embodiment, the outer portion 50 rotates relative to the inner portion to adjust the angular position of the shelf edge rail device. In addition, as shown in FIG. 7B, the mounting bracket may include a biasing mechanism 56, such as a coil spring as shown in FIG. 7B for example, and a biasing end portion 58 that biases the shelf edge rail device towards the straight position.

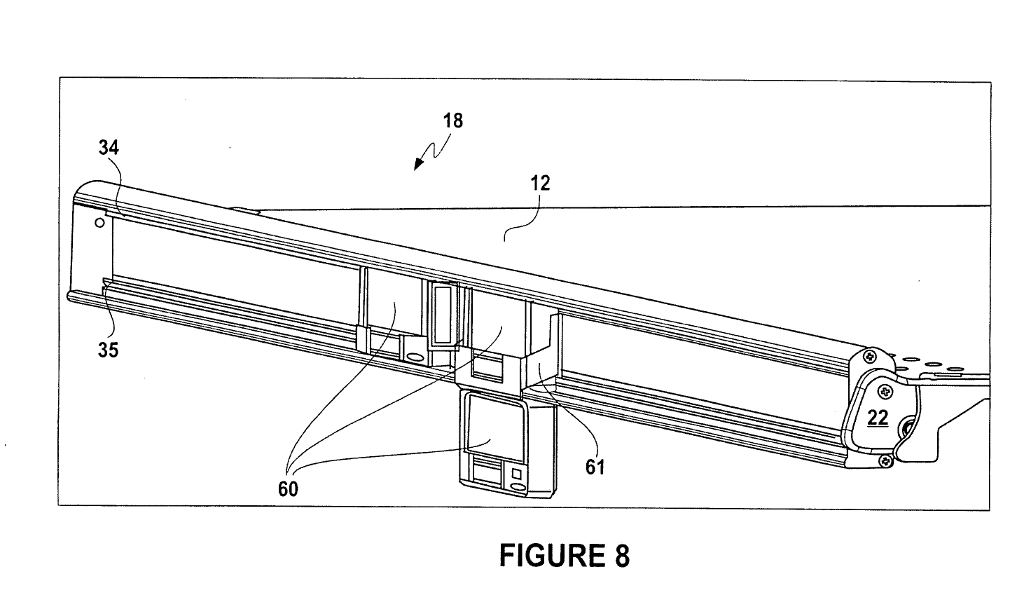

FIG. 8 illustrates the exemplary embodiment of a shelf edge rail device 18 shown in FIG. 3-5 with various display devices 60 mounted in the shelf edge rail device 18 or below the shelf edge rail device. As shown in FIG. 8, the shelf edge rail device may also include a bracket 61 that fit around a display device (without obscuring the display functions of that display device) so that another display device can be mounted below, above or to the side of the display device(s). Thus, more display devices can be mounted using the shelf edge display device. As shown, one or more display devices may be snapped into the shelf edge rail device so that an optimum viewing angle for the display device for a particular shelf or bay shelf at a particular height above the floor of the store can be achieved. The shelf edge rail device may be used with a plurality of different display devices, including electronic display devices, electronic display devices with wireless capabilities, etc. as long as those display devices fit into the mounting channel 20. Furthermore, the actual shape and configuration of the shelf edge rail device may be changed so that the shelf edge rail device can accommodate any display device with any size, shape of configuration.

While the foregoing has been with reference to a particular embodiment of the shelf-edge rail system and method, it will be appreciated by those skilled in the art that changes in this embodiment may be made without departing from the principles and spirit of the shelf-edge rail system and method, the scope of which is defined by the appended claims.

1. A shelf edge device, comprising:
a shelf edge rail device rotatably mounted on a shelf edge that has an adjustable angular position, the shelf edge rail device capable of retaining one or more display devices at an angle based on a height of the shelf relative to a floor of a store;
the shelf edge rail device further comprising a C-shaped mounting channel capable of receiving the one or more display devices and a mounting bracket located one end of the mounting channel that secures the mounting channel to a shelf; and
wherein the shelf edge rail device protects the display device from damage.

2. The device of claim 1, wherein the mounting channel further comprises a first and second end portion at each end of the mounting channel, a curved top portion attached to the first and second end portions, a curved bottom portion attached to the first and second end portions and a biasing strip located inside of the mounting channel that is capable of biasing a display device in the mounting channel against at least one of the curved top portion and curved bottom portion to securely hold the display device in the mounting channel.

3. The device of claim 2, wherein the first and second end portions are metal, the curved top portion is plastic and the curved bottom portion is plastic.

4. The device of claim 1, wherein the shelf edge rail device has a fixed angular position.

5. The device of claim 1, wherein the mounting bracket further comprises a ratcheting mechanism and a set of teeth wherein the ratcheting mechanism and the set of teeth cooperate to maintain the shelf edge rail device in a particular adjustable angular position.

6. The device of claim 5, wherein the angular position of the shelf edge rail device is manually adjustable.

7. The device of claim 1, wherein the C-shaped mounting channel further comprises a mounting channel inside of the C-shaped mounting channel that holds a paper tag or a paper strip inside of the C-shaped mounting channel.

8. The device of claim 5, wherein the mounting bracket further comprises a biasing mechanism that biases the shelf edge rail device to a straight position.

9. The device of claim 1, wherein the mounting bracket further comprises a tab for removable securing the shelf edge rail device to the shelf.

10. A shelving system of a floor of a store, comprising:
a plurality shelf units, each shelf unit having one or more shelves wherein each shelf has a shelf edge located adjacent an aisle and each shelf is capable of displaying an item to a consumer;
each shelf having a shelf edge mounted on the shelf that has an adjustable angular position, the shelf edge capable of retaining one or more display devices at an angle based on a height of the shelf relative to a floor of the store; and
wherein the shelf edge protects the display device from damage.

11. The system of claim 10, wherein each shelf unit has one or more bays and each bay has the one or more shelves.

12. The shelving system of claim 10, wherein each shelf edge further comprises a C-shaped mounting channel capable of receiving the one or more display devices and a mounting bracket located on C-shaped mounting channel that secures the C-shaped mounting channel to the shelf.

13. The system of claim 12, wherein the mounting channel further comprises a first and second end portion at each end of the mounting channel, a curved top portion attached to the first and second end portions, a curved bottom portion attached to the first and second end portions and a biasing strip located inside of the mounting channel that is capable of biasing a display device in the mounting channel against at least one of the curved top portion and curved bottom portion to securely hold the display device in the mounting channel.

14. The system of claim 13, wherein the first and second end portions are metal, the curved top portion is plastic and the curved bottom portion is plastic.

15. The system of claim 12, wherein the C-shaped mounting channel further comprises a mounting channel inside of the C-shaped mounting channel that holds a paper tag or a paper strip inside of the C-shaped mounting channel.

16. The system of claim 10, wherein the shelf edge has a fixed angular position.

17. The system of claim 12, wherein the mounting bracket further comprises a ratcheting mechanism and a set of teeth wherein the ratcheting mechanism and the set of teeth cooperate to maintain the shelf edge in an adjustable angular position.

18. The system of claim 17, wherein the angular position of the shelf edge is manually adjustable.

19. The system of claim 17, wherein the mounting bracket further comprises a biasing mechanism that biases the shelf edge to a straight position.

20. The system of claim 12, wherein the mounting bracket further comprises a tab for removable securing the shelf edge to the shelf.

21. A method for shelving items in a floor of a store, the method comprising:
providing a plurality shelf units, each shelf unit having one or more shelves wherein each shelf has a shelf edge located adjacent an aisle and each shelf is capable of displaying an item to a consumer;
providing, for each shelf, a shelf edge rail device rotatably mounted on the shelf edge that has an adjustable angular position;
adjusting the angular position of each shelf edge rail device based on a height of the shelf relative to a floor of the store; and
inserting a display device into the shelf edge rail device having the predetermined angular position to provide an optimal viewing angle for a display device in the shelf edge rail device and to protect the display device from damage.

22. The method of claim 21, wherein adjusting the angular position of each shelf edge rail device further comprises manually adjusting the angular position of each shelf edge rail device.

23. The method of claim 22, wherein manually adjusting the angular position of each shelf edge rail device further comprises manually adjusting the angular position of each shelf edge rail device to a predetermined position.
